(19) United States
(12) Patent Application Publication
(10) Pub. No.: US 2015/0112742 A1
(43) Pub. Date: Apr. 23, 2015

(54) SYSTEM AND METHOD OF AUTOMATICALLY ALLOCATING TASKS

(71) Applicant: Mitchell International, Inc., San Diego, CA (US)

(72) Inventors: Marcos Rivera, San Diego, CA (US); Scott Baierl, San Diego, CA (US); Bryan Durant, San Diego, CA (US); Russell Peters, San Diego, CA (US); Basab Dattaray, San Diego, CA (US)

(73) Assignee: Mitchell International, Inc., San Diego, CA (US)

(21) Appl. No.: 14/058,128

(22) Filed: Oct. 18, 2013

(51) Int. Cl. G06Q 10/06

(52) U.S. Cl. CPC G06Q 10/063114; G06Q 10/063112
USPC 705/7.14; 705/7.15

(57) ABSTRACT

Systems and methods of allocating tasks to servicers are disclosed. The systems and methods select one of the servicers and one of the tasks based on selection criteria. The systems and methods then determine whether the selected task may be allocated to the selected servicer. If the selected task may be allocated to the selected servicer, the systems and methods allocate the task accordingly. If the selected task may not be allocated to the selected servicer, the systems and methods select another one of the servicers and another one of the tasks.

### BACKGROUND

The present invention generally relates to systems and methods of allocating multiple tasks to multiple servicers, and more particularly to systems and methods of allocating tasks to servicers, where each of the tasks and each of the servicers are associated with a geographical location.

Various industries provide services to customers at different locations. For example, a real estate appraisal service provider uses a number of real estate appraisers to generate appraisals for properties at different locations on behalf of a number of real estate owners. Each day, for example, each appraiser receives a number of assignments for appraisal tasks to be performed at different locations.

The problem of determining which appraiser should receive which of the appraisal tasks is computationally complex and can require large amounts of computing resources to perform. Because the problem is NP-complete (nondeterministic polynomial time), an optimum solution may be found only by considering all possible solutions, and comparing the solutions based on a metric or rule whose outcome is to be optimized.

The metric to be optimized may be the outcome of, for example, finishing all of the appraisal tasks as early as possible, based on estimated durations of each of the appraisal tasks and estimated durations of other activities of each of the appraisers, such as travel, documentation, and the like. In such an example, to find the optimum solution, all possible solutions are calculated, and the completion time of the last time of appraisal of all the appraisers is calculated for each of the solutions. The solution having the earliest (minimum) last completion time is then selected as the optimum solution.

The computational load for finding an optimum solution increases exponentially with the number of appraisals and the number of appraisers. Because all possible solutions are calculated, this method of distributing appraisal tasks is impractical for situations having more than a few appraisers.

### BRIEF SUMMARY

One inventive aspect is a computer implemented method of allocating a plurality of tasks to a plurality of servicers. The method includes selecting a first servicer of the servicers, selecting a first task of the tasks, and determining whether the selected first task is allocatable to the selected first servicer. In response to the selected first task not being allocatable to the selected first servicer selecting a second servicer of the servicers, the method includes selecting a second task of the tasks, determining whether the selected second task is allocatable to the selected second servicer, and allocating the selected second task to the selected second servicer in response to the selected second task being allocatable to the selected second servicer.

Another inventive aspect is a computer system, that includes a processor, and a memory. The memory includes instructions that, when executed by the processor, cause the computer system to perform a method of allocating a plurality of tasks to a plurality of servicers. The performed method includes selecting a first servicer of the servicers, selecting a first task of the tasks, and determining whether the selected first task is allocatable to the selected first servicer. In response to the selected first task not being allocatable to the selected first servicer selecting a second servicer of the servicers, the method includes selecting a second task of the tasks, determining whether the selected second task is allocatable to the selected second servicer, and allocating the selected second task to the selected second servicer in response to the selected second task being allocatable to the selected second servicer.

Another inventive aspect is a computer readable medium including non-transient instructions that, when executed by a computer, cause the computer to perform a method of allocating a plurality of tasks to a plurality of servicers. The performed method includes selecting a first servicer of the servicers, selecting a first task of the tasks, and determining whether the selected first task is allocatable to the selected first servicer. In response to the selected first task not being allocatable to the selected first servicer selecting a second servicer of the servicers, the method includes selecting a second task of the tasks, determining whether the selected second task is allocatable to the selected second servicer, and allocating the selected second task to the selected second servicer in response to the selected second task being allocatable to the selected second servicer.

### BRIEF DESCRIPTION OF THE DRAWINGS

FIG. 1 is a schematic illustration of an exemplary task allocation system.

FIG. 2 is a graphical illustration of a task allocation problem for a service provider.

FIG. 3 is a structured flowchart diagram illustrating a method used by a computer to allocate tasks.

FIG. 4 is a graphical illustration of a task allocation problem for a service provider.

FIG. 5 is a structured flowchart diagram illustrating an alternative method used by a computer to allocate tasks.

FIG. 6 is a graphical illustration of a task allocation problem for a service provider.

FIG. 7 shows a configuration for a computer system constructed in accordance with the present disclosure.

### DETAILED DESCRIPTION

Particular embodiments of the invention are illustrated herein in conjunction with the drawings.

Various details are set forth herein as they relate to certain embodiments. However, the invention can also be implemented in ways which are different from those described herein. Modifications can be made to the discussed embodiments by those skilled in the art without departing from the invention. Therefore, the invention is not limited to particular embodiments disclosed herein.

In order to allocate tasks for more than a few servicers, finding an optimum solution may be impractical. However, using embodiments of systems and methods described herein, a near optimum solution may be calculated using a practical amount of computing resources and time.

Numerous industries allocate tasks among multiple servicers, and may benefit from the embodiments discussed herein. Industries such as home or building repair services, sales, claims processing, and mail or package delivery, which serve customers at different locations using multiple servicers, are particularly benefited by the embodiments discussed herein. While real estate appraisal services are discussed herein as an example, the various aspects and principles presented also apply to other industries.

In the examples, appraisers function as servicers, who are those assigned with performing the appraisal task. Each appraisal task is assigned to one of the appraisers. The appraisal tasks are allocated to each of the various appraisers by a computer system according to aspects and principles of the exemplary methods described below.

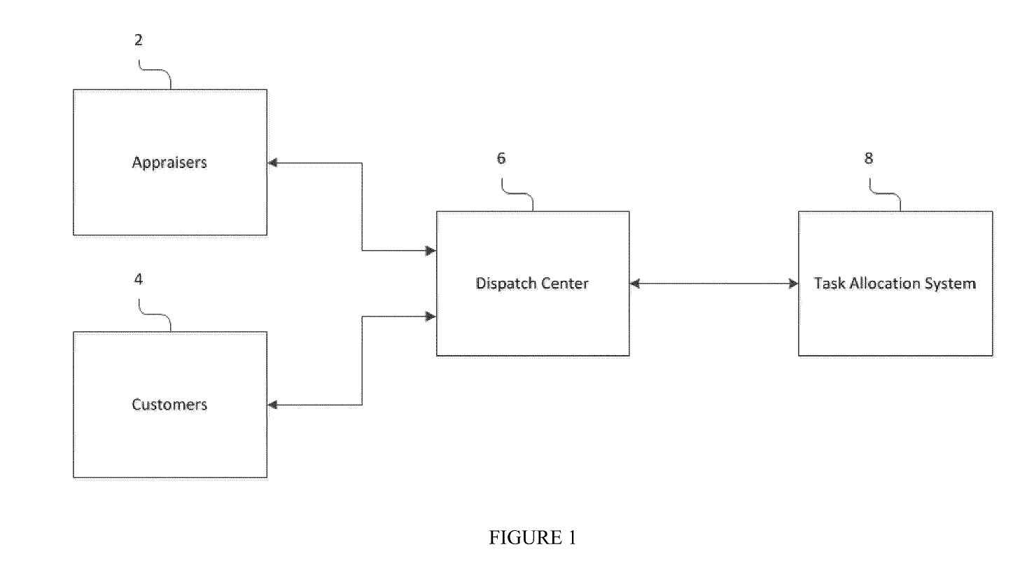

FIG. 1 is a schematic illustration of an exemplary task allocation system. The system includes appraisers 2, who provide information, for example regarding their availability, to a dispatch center 6, for example via an electronic communications network connecting the two. The FIG. 1 system also includes customers 4, who request appraisal jobs from the dispatch center 6, for example via an electronic communications network connecting the two. In some embodiments, the customers may include one or more insurance companies, which are in need of appraisers to assess damages for claims processing. Although the appraisers 2 are represented by a single box in FIG. 1, it should be understood that a plurality of appraisers are represented by the single box 2. Similarly, the customers 4 are represented by a single box in FIG. 1, but comprise a plurality of customers.

The dispatch center 6 receives the information from the appraisers 2 and the requests from customers 4. The information from the multiple sources may be packaged, and delivered from the dispatch center 6 to a task allocation system 8, for example via an electronic communications network connecting the two.

The task allocation system 8 receives the information regarding the appraisers 2 and the requested appraisal jobs or tasks, and allocates the appraisal jobs or tasks among the appraisers 2. Once the allocations have been determined, the task allocation system 8 communicates the allocations to the dispatch center 6 via the network. The dispatch center 6 communicates the allocations for each appraiser to the respective appraisers via the network. In some embodiments, the dispatch center 6 also communicates the allocations for each customer to the respective customers via the network.

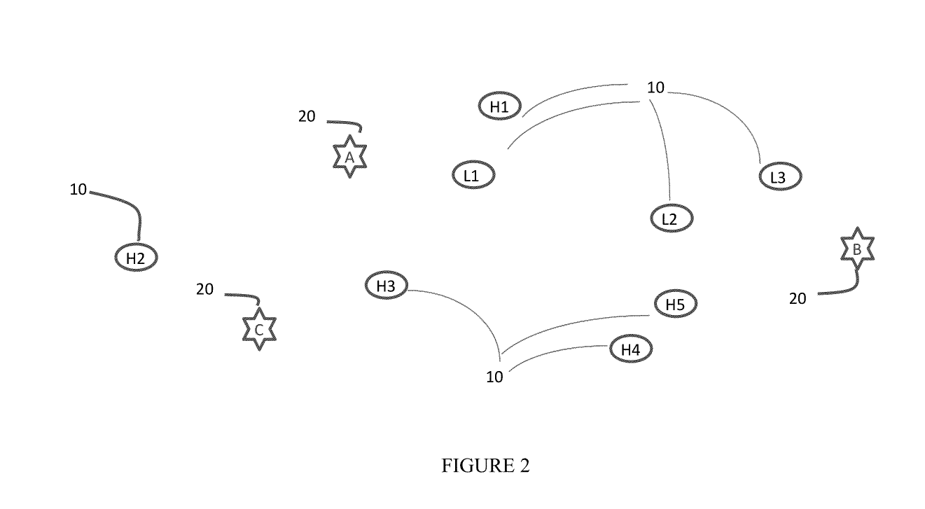

FIG. 2 is a graphical representation of a task allocation problem for a service provider. While the illustrated specific example may be small enough that an optimum solution may be practical, the example is for discussion purposes, and is used to illustrate various aspects and principles that may be applied to task allocation problems that are large enough that an optimum solution is not practical.

The problem presented in FIG. 2 includes multiple appraisers 20 and multiple appraisal tasks 10, which, for example, are to be completed according to a deadline associated with the task allocation process. For example, the appraisal tasks 10 may be due for completion by a “next day” deadline. In some embodiments, tasks may be due for completion by another time period, for example, by a next hour, by a next week, or by a next month. In this FIG. 2 example, each of the appraisal tasks 10 is given an urgency ranking of H (high) or L (low). In addition, each of the appraisal tasks 10 is given a task number for identification. Accordingly, it can be seen that there are five high-urgency tasks labeled H1-H5, and there are also three low-urgency tasks labeled L1-L3. In addition, there are three appraisers 20 labeled A, B, and C. Tasks are to be allocated to each of the appraisers 20 so that the appraisal tasks 10 may be completed the following day.

Each of the appraisers 20 has certain attributes. For example, each appraiser 20 may be associated with a geographical location, which, for example, may be their home location or their office location. In addition, each of the appraisers 20 may have a schedule, which may include fixed events, such as a meeting from 10 AM to 11 AM, and/or may include sliding events, such as a one hour lunch break anytime between 11 AM and 1 PM, or another event having a duration, and earliest start time, and a latest end time. Additional appraiser attributes may include certifications of certain types of appraisals, or an affinity for certain customers or certain types of customers. For example, each appraiser may be required for or may be precluded from servicing certain customers. In some embodiments, appraiser attributes may include at least one attribute of a set of attributes: appraiser skills, work day start time, and work day end time. The appraisers 20 may have other attributes.

Each of the appraisal tasks 10 has certain attributes. For example, each task 10 may be associated with a geographical location. In addition, each of the appraisal tasks 10 may have a schedule of availability, such as between 1 PM and 5 PM. Additional task attributes may include a type of appraisal, or that the property includes a pool or other special feature. Task attributes may additionally or alternatively include an affinity indicator or designator for certain appraisers. For example, each task may have a list of one or more required or precluded appraisers. In some embodiments, task attributes additionally or alternatively include a start time, or an end time. The tasks 10 may have other attributes as well.

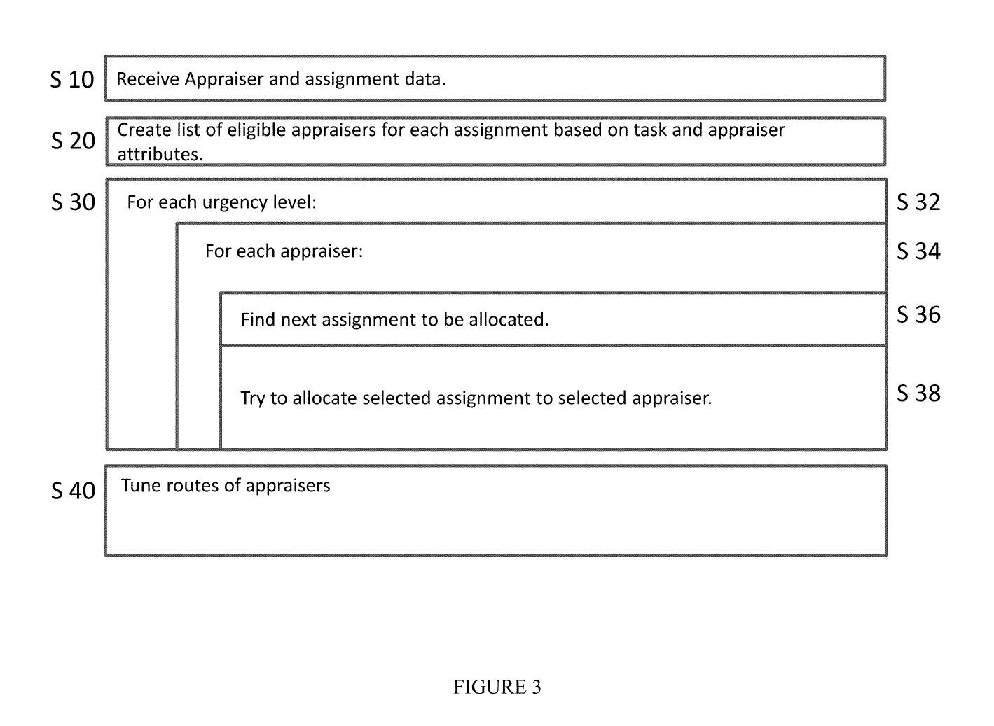

FIG. 3 is a structured flowchart diagram illustrating a method used by a computer, such as a server, to allocate tasks as described herein.

In the first computer operation, step S 10 of FIG. 3, the computer receives data associated with the tasks and the appraisers. The data includes the geographical locations associated with each of the tasks and with each of the appraisers. The data also includes the appraiser attributes and the task attributes. In some embodiments, the data is tested by the computer to ensure validity and usability of the data before further proceeding.

In step S 20, the computer generates a list of eligible appraisers for each task. For example, each task may have certain requirements as defined by the task attributes. In addition, based on the appraiser attributes, each appraiser has certain qualifications. For example, the task attributes for one of the tasks may include that the appraisal is for a house having an in-home theater. Certain appraisers may be certified in appraising such theaters. In step S 20, for each task, the computer generates a list of eligible appraisers based on the task attributes and the appraiser attributes. As a result, for the task of the appraisal of the house having the in-home theater, only appraisers having the appropriate certification are included in the list.

In some embodiments, a center of gravity is calculated for each of the appraisers in step S 20. The center of gravity may be based on, for example, the location of the home of the appraiser and all tasks within a specified distance of the home of the appraiser. In some embodiments, the center of gravity is calculated based at least in part on the locations of a specified quantity of nearest tasks, for example, the ten nearest tasks. The center of gravity may be calculated, for example, as a geometric mean of the task locations. The center of gravity may be calculated in other ways, and using other sets of data.

In step S 30, the computer allocates tasks to appraisers based in part on the list generated in step S 20. To do this, at step S 32, the computer determines a set of tasks having a next highest urgency level. For example, in step S 32, the computer starts the process using tasks having the highest urgency level, and changes the urgency level towards levels of less urgency as sets of tasks are allocated. For example, the computer may select all of the un-allocated tasks having the highest urgency level for inclusion in the set of tasks. As a result, tasks are allocated in order of urgency, starting with the highest and proceeding to the lowest. For each set of tasks determined in S 32, the computer performs steps S 34, S 36, and S 38, as described further below. Once the computer has performed S 34, S 36, and S 38 for each of the sets of tasks determined in S 32, the computer performs step S 40 described below.

At S 34, the computer selects a next appraiser to consider for allocation of a task. For example, the computer may select an appraiser having the lightest workload for the day. In some embodiments, the computer may select an appraiser having the lightest workload for another time duration, for example, for the past week, or for the past month. Other methods of appraiser selection may be used. After a next appraiser is selected, the computer proceeds to step S 36.

At S 36, the computer selects a next task to be allocated from the set determined in S 32. To do this, the computer selects one of the as yet unallocated tasks of the set. In some embodiments, the selection of the unallocated task is arbitrary. In such cases, the selection may be done, for example, in numeric order, alphabetically, or according to a time associated with the tasks, such as the time of customer request.

In some embodiments, the selection is performed according to other selection criteria. For example, the computer may select the unallocated task of the set which is nearest the location of the task most recently allocated to the appraiser selected in step S 34, or which is nearest the location of the home of the appraiser selected in step S 34 if no tasks have been previously allocated to the appraiser selected in step S 34.

In some embodiments, the computer selects the unallocated task of the set which is nearest the center of gravity, discussed elsewhere herein. In some embodiments, the computer selects the unallocated task of the set which is nearest the center of gravity as a first task allocated to the appraiser selected in step S 34. In some embodiments, subsequent unallocated tasks are selected based on proximity to the location of the task most recently allocated to the appraiser selected in step S 34.

In some embodiments, certain unallocated tasks may be precluded from selection based on the identity of the appraiser selected in step S 34. For example, if a particular unallocated tasks has been previously selected for potential allocation to the appraiser selected in step S 34, a repeat selection of the particular unallocated tasks may be precluded. This may be accomplished, for example, by maintaining a list of failed allocations for each appraiser. As part of the selection process, the computer may reference the list for the appraiser selected in step S 34, and exclude any tasks on the list from selection.

At S 38, the computer determines whether the task selected in S 36 may be allocated to the appraiser selected in S 34. To do this, the computer accesses the list of eligible appraisers generated in step S 20 for the task selected in S 36. If the appraiser selected at S 34 does not appear on the list of eligible appraisers for the task selected in S 36, the task is not allocatable to the appraiser selected at S 34. In response, the computer returns to S 34, where a next appraiser is selected to receive an appraisal task.

In some embodiments, the computer determines that the task selected in S 36 may not be allocated to the appraiser selected in S 34 based on other factors, not described herein. If, for any reason, the computer determines that the task selected in S 36 is not allocatable to the appraiser selected in S 34, the computer may add the task selected in S 36 to a list of failed allocations for the appraiser selected in S 34.

If, however, the appraiser selected at S 34 does appear on the list of eligible appraisers for the task selected in S 36, the computer determines whether the schedule of the appraiser selected in S 34 may accommodate the task selected in S 36. The determination may be made by comparing the schedule of the appraiser selected in S 34 with the expected task duration as included in the task attributes of the task selected in S 36, and with expected travel time calculated based on at least one of the location of a next previous task, the home of the appraiser, and a current location of the appraiser. In some embodiments, allocation of the task selected in S 36 may be conditioned on sufficient time for the appraiser selected in S 34 to travel home by a certain time after completing the task selected in S 36. In some embodiments, whether the schedule of the appraiser selected in S 34 accommodates the task selected in S 36 is based at least in part on a distance between the location of the task selected in S 36 and the center of gravity of the appraiser. If the schedule of the appraiser selected in S 34 does not accommodate the task selected in S 36, the task is not allocatable to the appraiser selected at S 34. In response, the computer returns to S 34, where a next appraiser is selected to receive a task.

If, however, the schedule of the appraiser selected in S 34 does accommodate the task selected in S 36, the computer allocates the task selected in S 36 to the appraiser selected in S 34. The computer then modifies the schedule of the appraiser selected in S 34 to include the newly allocated task. The modification is made according to task attributes of the newly allocated task. After the task is allocated, the computer returns to step S 34 for selection of a next appraiser to consider for task allocation.

At the conclusion of step S 30, each of the appraisers has been considered for receiving tasks, and each of the tasks has been considered for allocation. However, the scheduled sequence of the tasks allocated to each appraiser has been determined based on the order the tasks were allocated. This schedule sequence may not be optimal.

At S 40, the task schedule for each of the appraiser is optimized. Various optimization routines may be used. In some embodiments, the locations of the tasks for an appraiser are used as a basis for optimizing the route of the appraiser. For example, the task located nearest the home or next previous task of the appraiser may be scheduled as the next task to be completed. In some embodiments, selection of a next task to be completed is based at least in part on a geometric analysis. For each candidate next task, an angle may be determined, where the determined angle is formed between first and second line segments. The first line segment connects the current task and the next previous task and the second line segment connects the current task and the candidate next task. Candidate next tasks having angles nearest 180° may be preferred in the selection process. In some embodiments, candidate next tasks having angles nearest 0° may be preferred in the selection process.

Once the task schedule for the appraisers has been optimized, the schedule of one or more of the appraisers may have been optimized such that it could accommodate one or more additional tasks. Accordingly, in some embodiments, steps S 10 through S 40 may be repeated one or more times to add additional tasks to the routes and schedules of the appraisers.

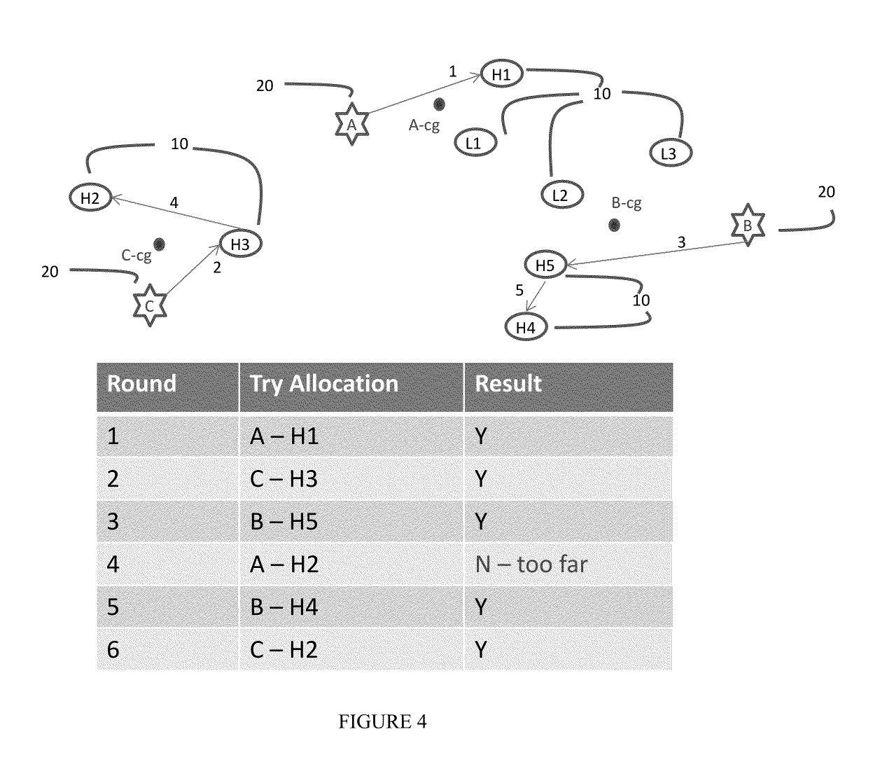

Thus, FIG. 1 is a schematic illustration of an exemplary task allocation system. FIG. 2 is a graphical illustration of a task allocation problem for a service provider. FIG. 3 is a structured flowchart diagram illustrating a method used by a computer, such as a server, to allocate tasks. FIG. 4 is a graphical illustration of a task allocation problem for a service provider, and includes a table of steps taken by the computer in performing the method of FIG. 3 to determine a solution. The problem illustrated in FIG. 4 includes appraisers 20 and appraisal tasks 10. Each of the appraisal tasks 10 is given an urgency ranking of H (high) or L (low) and a numerical identifier as in FIG. 2.

The table of FIG. 4 illustrates the activity at each occurrence of step S 38 as a computer performs the method represented by the structured flow diagram of FIG. 3. The operations of S 38 are performed iteratively, each occurrence after another. In each occurrence of step S 38, the computer determines whether the task previously selected in step S 36 may be allocated to the appraiser previously selected in step S 34, and allocates the task if appropriate. The computer otherwise processes the next appraiser.

Prior to occurrence 1 of step S 38, the computer selects appraiser A, and task H1, in steps S 34 and S 36, respectively. In occurrence 1 of S 38, represented by the data in the table for the row marked “Round 1”, the computer determines that task H1 may be allocated to appraiser A based on, for example, task H1 being less than a maximum distance from the home of appraiser A, such that appraiser A has sufficient time to travel to task H1, complete task H1, and have a lunch break during a lunch break window.

The computer then repeats steps S 34 and S 36, selecting appraiser C and task H3. In occurrence 2 of S 38, represented by the data in the table for the row marked “Round 2”, the computer determines that task H3 may be allocated to appraiser C. Likewise, the computer repeats steps S 34 and S 36, selecting appraiser B and task H5. In occurrence 3 of S 38, the computer determines that task H5 may be allocated to appraiser B, represented by the data for the row marked “Round 3”.

The computer then repeats steps S 34 and S 36, selecting appraiser A and task H2. In occurrence 4 of S 38, the computer determines that task H2 may not be allocated to appraiser A based on, for example task H2 being greater than a maximum distance from the previous task (H1) of appraiser A.

The computer then repeats steps S 34 and S 36, selecting appraiser B and task H4. In occurrence 5 of S 38, the computer determines that task H4 may be allocated to appraiser B. Likewise, the computer repeats steps S 34 and S 36, selecting appraiser C and task H2. In occurrence 6 of S 38, the computer determines that task H2 may be allocated to appraiser C.

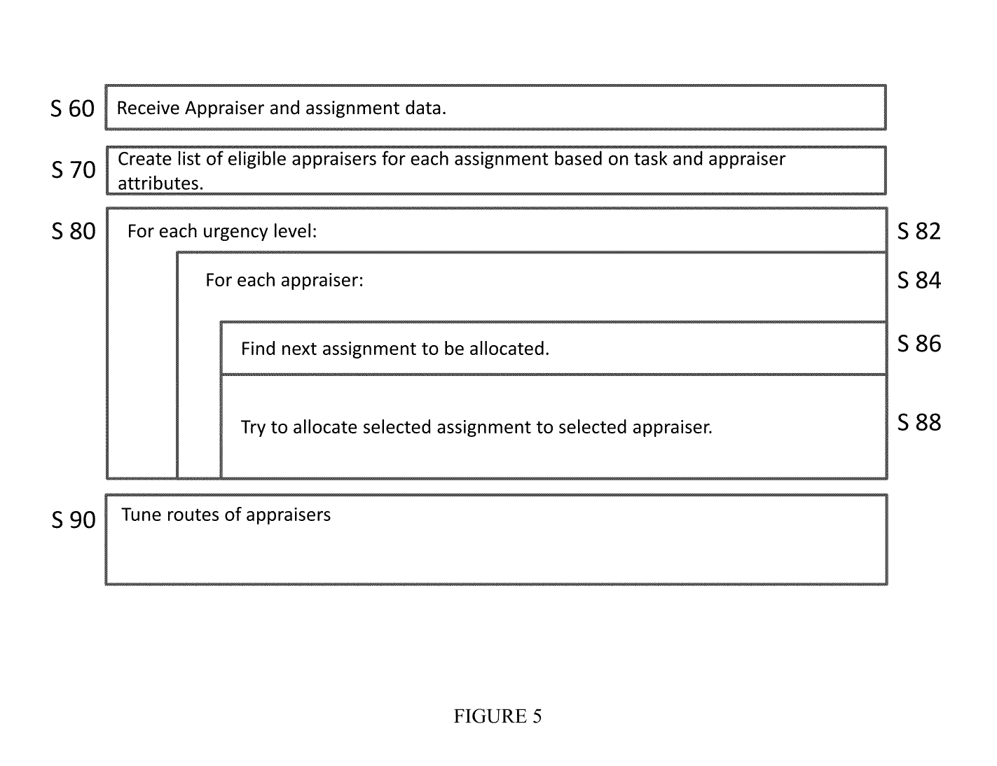

FIG. 5 is a structured flowchart diagram illustrating an alternative method used by a computer, such as a server, to allocate tasks using a load maximizing scheme.

In step S 60, the computer receives data associated with the tasks and the appraisers. The data includes the geographical locations associated with each of the tasks and with each of the appraisers. The data also includes the appraiser attributes and the task attributes. In some embodiments, the data is tested by the computer to ensure validity and usability of the data before further proceeding.

In step S 70, the computer generates a list of eligible appraisers for each task. For example, each task may have certain requirements as defined by the task attributes. In addition, based on the appraiser attributes, each appraiser has certain qualifications. For example, the task attributes for one of the appraisal task may include that the appraisal is for a house having an in-home theater. Certain appraisers may be certified in appraising such theaters. In step S 70, for each task, the computer generates a list of eligible appraisers based on the tasks attributes and the appraiser attributes. As a result, for the task of the appraisal of the house having the in-home theater, only appraisers having the appropriate certification are included in the list.

In some embodiments, a center of gravity is calculated for each of the appraisers. The center of gravity may be based on the location of the home of the appraiser and all tasks within a specified distance of the home of the appraiser. In some embodiments, the center of gravity is calculated based at least in part on the locations of a specified quantity of nearest tasks, for example, the nearest 10 tasks. The center of gravity may be calculated, for example, as a geometric mean of the locations. The center of gravity may be calculated in other ways, and using other sets of data.

In step S 80, the computer allocates tasks based in part on the list generated in step S 70. To do this, at step S 82, the computer determines a set of tasks having a next highest urgency level. For example, in step S 82, the computer starts the process using tasks having the highest urgency level, and changes the urgency level towards levels of less urgency as sets of tasks are allocated. For example, the computer may select all of the un-allocated tasks having the highest urgency level for inclusion in the set of tasks. As a result, tasks are allocated in order of urgency, starting with the highest. For each set of tasks determined in S 82, the computer performs steps S 84, S 86, and S 88, as described below. Once the computer has performed S 84, S 86, and S 88 for each of the sets of tasks determined in S 82, the computer performs step S 90 described below.

At S 84, the computer selects a next appraiser to consider for task allocation. For example, the computer may select an appraiser having the lightest workload for the day. In some embodiments, the computer may select an appraiser having the lightest workload for another time duration, for example, for the past week, or for the past month. Other methods of appraiser selection may be used. After a next appraiser is selected, the computer proceeds to step S 86.

At S 86, the computer selects a next task to be allocated from the set determined in S 82. In some embodiments, the computer modifies the set determined in S 82 such that the modified set includes only those tasks which are allocatable to the appraiser selected in step S 84.

To do this, the computer selects one of the as yet unallocated tasks of the set. In some embodiments, the selection of the unallocated task is arbitrary. In such cases, the selection may be done, for example, in numeric order, alphabetically, or according to a time associated with the tasks, such as the time of customer request.

In some embodiments, the selection is performed according to other selection criteria. For example, the computer may select the unallocated task of the set which is nearest the location of the task most recently allocated to the appraiser selected in step S 84, or which is nearest the location of the home of the appraiser selected in step S 84 if no tasks have been previously allocated to the appraiser selected in step S 84.

In some embodiments, the computer selects the unallocated task of the set which is nearest the center of gravity, discussed elsewhere herein. In some embodiments, the computer's selects the unallocated task of the set which is nearest the center of gravity as a first task allocated to the appraiser selected in step S 84. In some embodiments, subsequent unallocated tasks are selected based on proximity to the location of the task most recently allocated to the appraiser selected in step S 84.

In some embodiments, certain unallocated tasks may be precluded from selection based on the identity of the appraiser selected in step S 84. For example, if a particular unallocated task has been previously selected for potential allocation to the appraiser selected in step S 84, a repeat selection of the particular unallocated task may be precluded. This may be accomplished, for example, by maintaining a list of failed allocations for each appraiser. As part of the selection process, the computer may reference the list for the appraiser selected in step S 84, and exclude any tasks on the list from selection.

At S 88, the computer determines whether the task selected in S 86 may be allocated to the appraiser selected in S 84. To do this, the computer accesses the list of eligible appraisers generated in step S 20 for the task selected in S 86. If the appraiser selected at S 84 does not appear on the list of eligible appraisers for the task selected in S 86, the task is unnalocatable to the appraiser selected at S 84. In response, the computer returns to S 84, where a next appraiser is selected to receive a task.

In some embodiments, the computer determines that the task selected in S 86 is unallocatable to the appraiser selected in S 84 based on other factors, not described herein. If, for any reason, the computer determines that the task selected in S 86 is unallocatable to the appraiser selected in S 84, the computer may add the task selected in S 86 to a list of failed allocations for the appraiser selected in S 84.

If, however, the appraiser selected at S 84 does appear on the list of eligible appraisers for the task selected in S 86, the computer determines whether the schedule of the appraiser selected in S 84 may accommodate the task selected in S 86. The determination may be made by comparing the schedule of the appraiser selected in S 84 with the expected task duration as included in the task attributes of the task selected in S 86, and with expected travel time calculated based on the location of a next previous task or home of the appraiser. In some embodiments, allocation of the task selected in S 86 may be conditioned on sufficient time for the appraiser selected in S 84 to travel home by a certain time after completing the task selected in S 86. In some embodiments, whether the schedule of the appraiser selected in S 84 accommodates the task selected in S 86 is based at least in part on a distance between the location of the task selected in S 86 and the center of gravity of the appraiser. If the schedule of the appraiser selected in S 84 does not accommodate the task selected in S 86, the task is unnalocatable to the appraiser selected at S 84. In response, the computer returns to S 84, where a next appraiser is selected to receive a task.

If, however, the schedule of the appraiser selected in S 84 does accommodate the task selected in S 86, the computer allocates the task selected in S 86 to the appraiser selected in S 84. The computer then modifies the schedule of the appraiser selected in S 84 to include the newly allocated task. The modification is made according to task attributes of the newly allocated task. After the task is allocated, the computer returns to step S 86 for selection of a next task for allocation.

At the conclusion of step S 80, each of the appraisers has been considered for receiving tasks, and each of the tasks has been considered for allocation. However, the scheduled sequence of the tasks allocated to each appraiser has been determined based on the order the tasks were allocated. This schedule sequence may not be optimal.

At S 90, the task schedule for each of the appraiser is optimized. Various optimization routines may be used. In some embodiments, the locations of the allocated tasks for an appraiser are used as a basis for optimizing the route of the appraiser. For example, the task located nearest the home or next previous task of the appraiser may be scheduled as the next task to be completed. In some embodiments, selection of a next task to be completed is based at least in part on a geometric analysis. For each candidate next task, an angle may be determined, where the determined angle is formed between first and second line segments. The first line segment connects the current task and the next previous task and the second line segment connects the current task and the candidate next task. Candidate next tasks having angles nearest 180° may be preferred in the selection process.

Once the task schedule for the appraisers has been optimized, the schedule of one or more of the appraisers may have been optimized such that it could accommodate one or more additional tasks. Accordingly, in some embodiments, steps S 60 through S 90 may be repeated one or more times to add additional tasks to the routes and schedules of the appraisers.

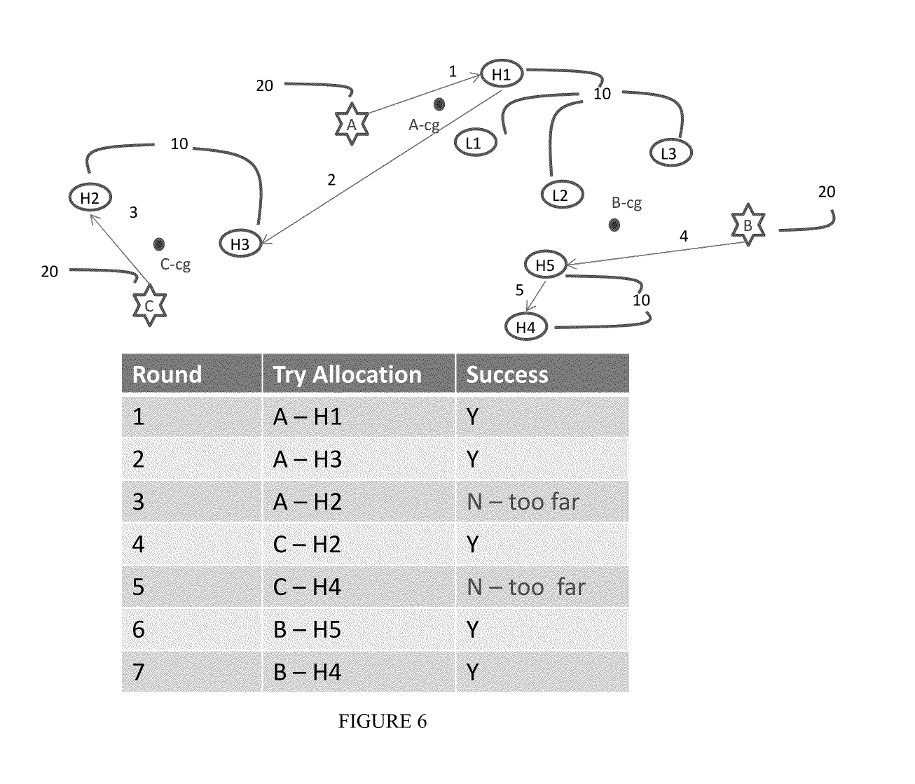

FIG. 6 is a graphical illustration of a task allocation problem for a service provider, and includes a table of steps taken by the computer in performing the method of FIG. 5 to determine a solution. The problem illustrated in FIG. 6 includes appraisers 20 and appraisal tasks 10. Each of the appraisal tasks 10 is given an urgency ranking of H (high) or L (low) and a numerical identifier as in FIG. 2.

The table of FIG. 6 illustrates the activity at each occurrence of step S 88 as a computer performs the method of FIG. 5. In each occurrence of step S 88, the computer determines whether the task previously selected in step S 86 may be allocated to the appraiser previously selected in step S 84, and allocates the task if appropriate.

Prior to occurrence 1 of step S 88, the computer selects appraiser A, and task H1, in steps S 84 and S 86, respectively. In occurrence 1 of S 88, the computer determines that task H1 may be allocated to appraiser A based on, for example, task H1 being closest to the center of gravity of appraiser A.

The computer then repeats step S 86, selecting H3. In occurrence 2 of S 88, the computer determines that task H3 may be allocated to appraiser A. Likewise, the computer repeats step S 86, selecting task H2. In occurrence 3 of S 88, the computer determines that task H2 may not be allocated to appraiser A.

The computer then repeats steps S 84 and S 86, selecting appraiser C and task H2. In occurrence 4 of S 88, the computer determines that task H2 may be allocated to appraiser C. The computer then repeats step S 86, selecting task H4. In occurrence 5 of S 88, the computer determines that task H4 may not be allocated to appraiser C.

The computer then repeats steps S 84 and S 86, selecting appraiser B and task H5. In occurrence 6 of S 88, the computer determines that task H2 may be allocated to appraiser B. The computer then repeats step S 86, selecting task H4. In occurrence 5 of S 88, the computer determines that task H4 may be allocated to appraiser C.

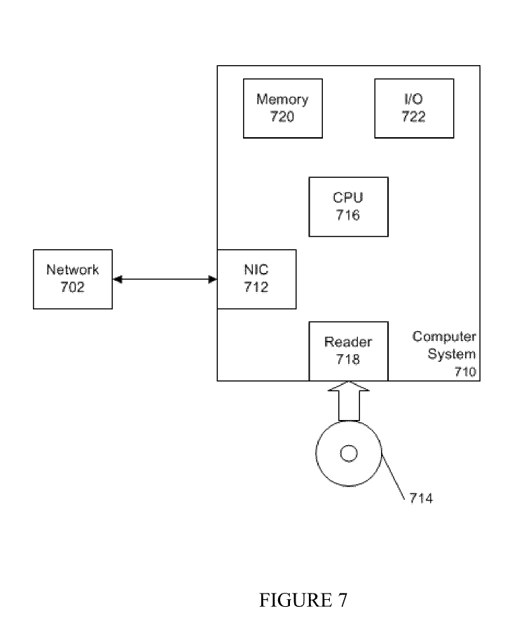

FIG. 7 shows a configuration for a computer system 710 constructed in accordance with the present disclosure. The computer system 710 can comprise a system such as a personal computer or server computer or the like. The computer system 710 may include a network communication interface 712 that permits communications with a network 702. The network interface can comprise a network interface card (NIC). The computer system 710 can execute instructions to provide a computer system which performs various aspects and principles of the methods and features described herein.

The computer system 710 includes a central processor unit 716 (CPU) and a program product reader 718 for receiving a program product media and reading program instructions recorded thereon, where the instructions, when executed by the computer cause the computer to perform various aspects and principles of the methods and features described herein. The computer system also includes associated memory 720 and input/output facilities 722, such as a display for output and a keyboard and/or mouse for input. The processor 716 of the computer system 710 can receive program instructions into the program memory of the processor. The program instructions can be received directly, such as by flashing EEPROM of the processor, or can be received through the network interface 712, such as by download from a connected device or over a WAN or LAN network communication. If desired, the program instructions can be stored on a computer program product 714 that is read by the computer system 710 so that the program instructions can thereafter executed. That is, the program product 714 is for use in a system such as the computer system 710, wherein the program product comprises a tangible, non-transitory recordable media containing a program of computer-readable instructions that are executable by the device processor 704 to perform the operations described herein. The program product 714 can comprise, for example, optical program media such as CD or DVD data discs, or flash memory drives, or external memory stores, or floppy magnetic disks, and the like.

The present invention has been described above in terms of presently preferred embodiments so that an understanding of the present invention can be conveyed. There are, however, many configurations for network devices and management systems not specifically described herein but with which the present invention is applicable. The present invention should therefore not be seen as limited to the particular embodiments described herein, but rather, it should be understood that the present invention has wide applicability with respect to network devices and management systems generally. All modifications, variations, or equivalent arrangements and implementations that are within the scope of the attached claims should therefore be considered within the scope of the invention.

What is claimed is:

1. A computer implemented method of allocating a plurality of tasks to a plurality of servicers, the method comprising:
selecting a first servicer of the servicers;
selecting a first task of the tasks;
determining whether the selected first task is allocatable to the selected first servicer;
allocating the selected first task to the selected first servicer in response to the selected first task being allocatable to the selected first servicer; and
in response to the selected first task not being allocatable to the selected first servicer:
selecting a second servicer of the servicers,
selecting a second task of the tasks,
determining whether the selected second task is allocatable to the selected second servicer,
allocating the selected second task to the selected second servicer in response to the selected second task being allocatable to the selected second servicer, and
in response to the selected second task not being allocatable to the selected second servicer:
selecting a next servicer of the servicers.

2. The method of claim 1, wherein each servicer has a workload associated therewith, and selecting the first servicer comprises comparing the workloads of the servicers and selecting the servicer having the lightest workload.

3. The method of claim 1, wherein each task has a location associated therewith, and selecting the first task comprises comparing distances between the locations of a plurality of unallocated tasks and the location of the task most recently allocated to the first servicer, and selecting the unallocated task which is closest to the location of the task most recently allocated to the first server.

4. The method of claim 1, further comprising generating a list of eligible servicers for each task, wherein determining whether the selected first task is allocatable to the selected first servicer comprises determining whether the selected first servicer is included in the list of eligible service for the selected first task.

5. The method of claim 4, wherein determining whether the selected first task is allocatable to the selected first servicer further comprises determining whether the schedule of the appraiser accommodates the task.

6. The method of claim 5, wherein the schedule of the appraiser comprises an event having:
a duration,
an earliest start time, and
a latest end time.

7. The method of claim 1, further comprising:
determining a skill requirement attribute for the first task; and
determining a skill attribute for the first servicer,
wherein determining whether the selected first task is allocatable to the selected first servicer comprises determining whether the skill attribute of the first servicer corresponds with the skill requirement attribute of the first task.

8. A computer system, comprising:
a processor; and
a memory, comprising instructions, which when executed by the process cause the computer system to perform a method of allocating a plurality of tasks to a plurality of servicers, the method comprising:
selecting a first servicer of the servicers;
selecting a first task of the tasks;
determining whether the selected first task is allocatable to the selected first servicer; and
in response to the selected first task not being allocatable to the selected first servicer:
selecting a second servicer of the servicers,
selecting a second task of the tasks,
determining whether the selected second task is allocatable to the selected second servicer, and
allocating the selected second task to the selected second servicer in response to the selected second task being allocatable to the selected second servicer.

9. The computer system of claim 8, wherein each servicer has a workload associated therewith, and selecting the first servicer comprises comparing the workloads of the servicers and selecting the servicer having the lightest workload.

10. The computer system of claim 8, wherein each task has a location associated therewith, and selecting the first task comprises comparing distances between the locations of a plurality of unallocated tasks and the location of the task most recently allocated to the first servicer, and selecting the unallocated task which is closest to the location of the task most recently allocated to the first server.

11. The computer system of claim 8, the method further comprising generating a list of eligible servicers for each task, wherein determining whether the selected first task is allocatable to the selected first servicer comprises determining whether the selected first servicer is included in the list of eligible service for the selected first task.

12. The computer system of claim 11, wherein determining whether the selected first task is allocatable to the selected first servicer further comprises determining whether the schedule of the appraiser accommodates the task.

13. The computer system of claim 12, wherein the schedule of the appraiser comprises an event having:
a duration,
an earliest start time, and
a latest end time.

14. The computer system of claim 8, the method further comprising:
determining a skill requirement attribute for the first task; and
determining a skill attribute for the first servicer,
wherein determining whether the selected first task is allocatable to the selected first servicer comprises determining whether the skill attribute of the first servicer corresponds with the skill requirement attribute of the first task.

15. A computer readable medium comprising non-transient instructions, which, when executed by a computer, cause the computer to perform a method of allocating a plurality of tasks to a plurality of servicers, the method comprising:
selecting a first servicer of the servicers;
selecting a first task of the tasks;
determining whether the selected first task is allocatable to the selected first servicer; and
in response to the selected first task not being allocatable to the selected first servicer:
selecting a second servicer of the servicers,
selecting a second task of the tasks,
determining whether the selected second task is allocatable to the selected second servicer, and
allocating the selected second task to the selected second servicer in response to the selected second task being allocatable to the selected second servicer.

16. The computer readable medium of claim 15, wherein each servicer has a workload associated therewith, and selecting the first servicer comprises comparing the workloads of the servicers and selecting the servicer having the lightest workload.

17. The computer readable medium of claim 15, wherein each task has a location associated therewith, and selecting the first task comprises comparing distances between the locations of a plurality of unallocated tasks and the location of the task most recently allocated to the first servicer, and selecting the unallocated task which is closest to the location of the task most recently allocated to the first server.

18. The computer readable medium of claim 15, the method further comprising generating a list of eligible servicers for each task, wherein determining whether the selected first task is allocatable to the selected first servicer comprises determining whether the selected first servicer is included in the list of eligible service for the selected first task.

19. The computer readable medium of claim 18, wherein determining whether the selected first task is allocatable to the selected first servicer further comprises determining whether the schedule of the appraiser accommodates the task.

20. The computer readable medium of claim 19, wherein the schedule of the appraiser comprises an event having:
a duration,
an earliest start time, and
a latest end time.

21. The computer readable medium of claim 15, the method further comprising:
determining a skill requirement attribute for the first task; and
determining a skill attribute for the first servicer,
wherein determining whether the selected first task is allocatable to the selected first servicer comprises determining whether the skill attribute of the first servicer corresponds with the skill requirement attribute of the first task.
